(19) United States
(12) Patent Application Publication
(10) Pub. No.: US 2008/0083785 A1
(43) Pub. Date: Apr. 10, 2008

(54) Snack dispenser

(76) Inventors: Jay Nelson, Rathdrum, ID (US); Merle O. Nelson, South Akeley, MN (US)

Correspondence Address: LITMAN LAW OFFICES, LTD., P.O. BOX 15035, CRYSTAL CITY STATION, ARLINGTON, VA, 22215, US

(21) Appl. No.: 11/542,172

(22) Filed: Oct. 4, 2006

(51) Int. Cl. B67D 5/64

(52) U.S. Cl. 222/175

(57) ABSTRACT

A portable container and dispenser for particulate snack food. The container is fashioned with a spout fabricated from elastic material, which spout can be opened or closed by manipulating the spout. A closable opening is provided for re-filling the container. A clip is disposed on the rear surface of the container for supporting the container from the belt of a user.

### BACKGROUND OF THE INVENTION

1. Field of the Invention

The present invention generally relates to dispensing devices. More specifically, the present invention is drawn to a portable device for dispensing particulate snack foods.

2. Description of the Related Art

When one's energy level wanes and hunger pangs strike, obtaining food becomes the driving force for mind and body. Often at such times, having a meal is not possible, so one procures the ever-popular snack. Lately, particulate foods such as sunflower seeds and the like have become popular as snack foods. The particulate foods are packaged in small bags and must be retrieved from one's pocket, handbag or backpack and poured from the bag before the snack can be enjoyed. This scenario often results in spillage, pouring too much, or pouring too little. How handy it would be if the snack food were stored in an easily accessible container and dispensed therefrom in desired quantities.

The related art is rife with devices for dispensing food and other small items. However, none of these devices, taken either singly or in combination, is seen to describe a dispenser for particulate snack food as will subsequently be described and claimed in the instant application.

### SUMMARY OF THE INVENTION

The invention is a portable container and dispenser for particulate snack food. The container is funnel-shaped and is fashioned with a spout, which spout can be opened or closed by simply squeezing the spout. The spout is fabricated from an elastic material so that manipulating or squeezing causes a slit in the end of the spout to open. A closable opening is provided for re-filling the container. A clip is disposed on the rear surface of the container for supporting the container from the belt of a user.

Accordingly, the invention presents a portable container for dispensing particulate snack food that is readily accessible, efficient and easy to use. The invention provides for improved elements thereof in an arrangement for the purposes described that are inexpensive, dependable and fully effective in accomplishing their intended purposes.

A clear understanding of the present invention will become readily apparent upon further review of the following specification and drawings.

### BRIEF DESCRIPTION OF THE DRAWINGS

FIG. 1 is an environmental, perspective view of a snack dispenser according to the present invention.

FIG. 2 is a front view of a snack dispenser according to the present invention.

FIG. 3 is a rear view of a snack dispenser according to the present invention.

Similar reference characters denote corresponding features consistently throughout the attached drawings.

### DETAILED DESCRIPTION OF THE PREFERRED EMBODIMENT

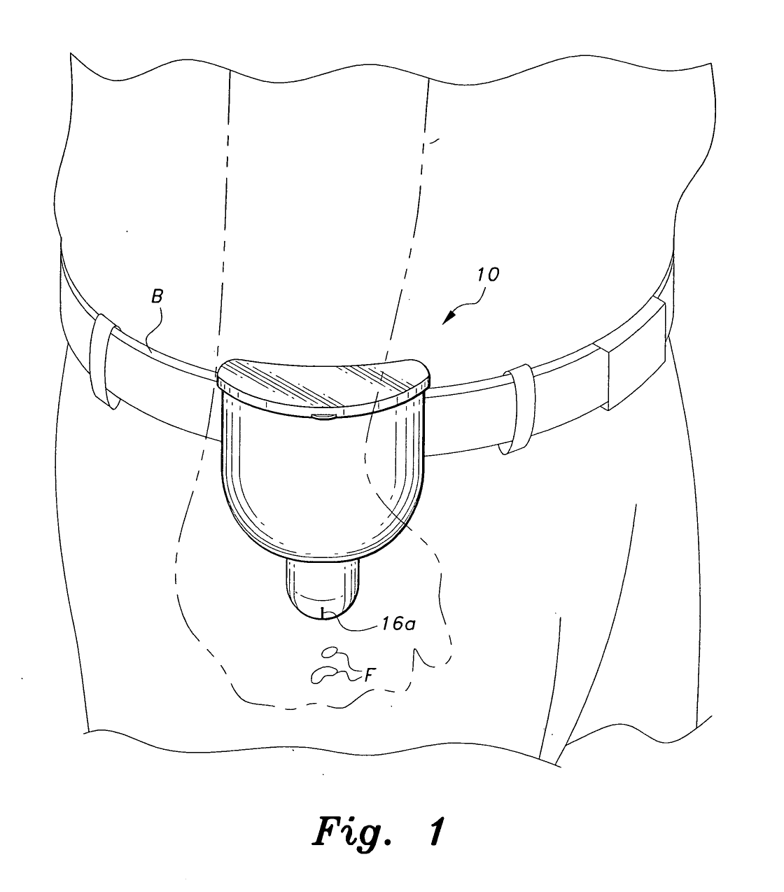

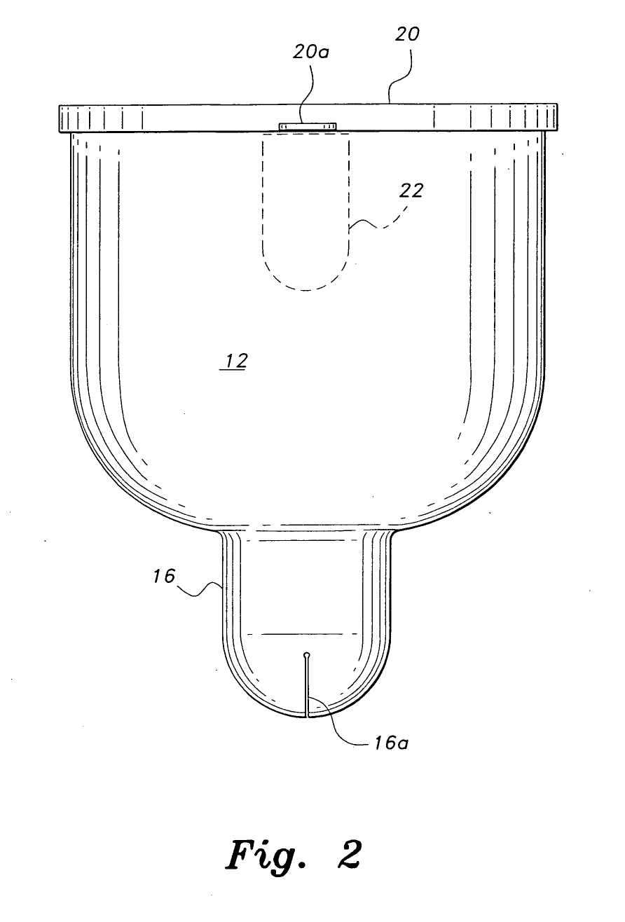

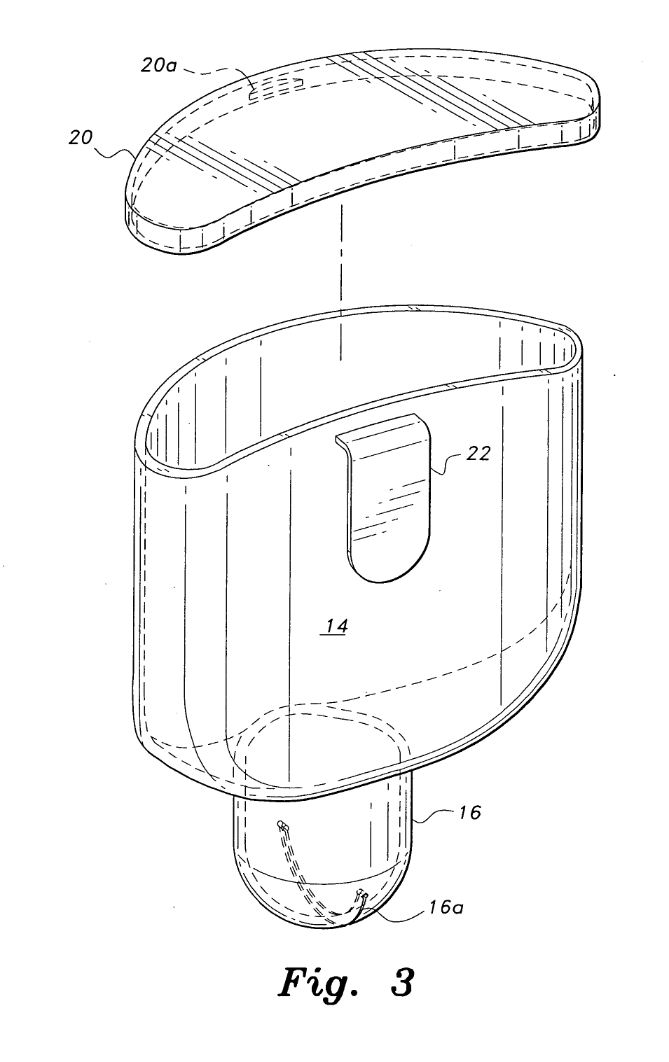

Attention is directed to FIGS. 1-3 wherein the dispensing container of the instant invention is generally indicated at 10. Container 10 comprises an open-top housing having front face 12 and rear face 14. The lower portion of the container is designed with inwardly tapering walls defining a dispensing spout 16. Dispensing spout 16 terminates in a normally closed slit 16a. Dispensing spout 16 is fabricated from elastic material. A hinged or removable lid 20 having a handle 20a is positioned to close the top of the container. A U-shaped clip 22 is affixed to rear face 14 for easy attachment to a user's belt or the like.

Using the device is very simple. Lid 20 is opened or removed so that the container may be filled with a particulate snack food. The lid 20 is then replaced to close the top of the container. The device is attached to the user's belt B utilizing clip 22. When a snack is desired, the user manipulates or squeezes spout 16 to open slit 16a and dispense snack food F. When the desired amount of snack food has been dispensed, pressure on spout 16 is released and slit 16a reverts to its normally closed state.

It is to be understood that the present invention is not limited to the embodiment described above, but encompasses any and all embodiments within the scope of the following claims.

I claim:

1. A snack dispenser for dispensing particulate snack food, comprising:
a container having an open top, a front face, a rear face and a lower portion;
a spout defining the lower portion of said container, said spout having an end;
an openable slit formed in the end of said spout;
said spout being fabricated from elastic material whereby manipulation of said spout causes said slit to open.

2. The snack dispenser for dispensing particulate snack food according to claim 1, further including a removable lid disposed on the open top of said container.

3. The snack dispenser for dispensing particulate snack food according to claim 1, further including a clip disposed on the rear face of said container.

4. A snack dispenser for dispensing particulate snack food, comprising:
a container having an open top, a front face, a rear face and inwardly tapering walls defining a dispensing spout, said dispensing spout having an end;
an openable slit formed in said end;
said spout being fabricated from elastic material whereby manipulation of said spout causes said slit to open;
a removable lid disposed on the open top of said container; and
a handle mounted on said removable lid.

5. The snack dispenser for dispensing particulate snack food according to claim 4, further including a clip disposed on the rear face of said container.

6. The snack dispenser for dispensing particulate snack food according to claim 5, wherein said clip is U-shaped.
